(19) United States
(12) Patent Application Publication
(10) Pub. No.: US 2011/0116904 A1
(43) Pub. Date: May 19, 2011

(54) System, Apparatus, and Method for Item Handling

(75) Inventors: Robert L. Stone, Perry Hall, MD (US); Mohammed T. Islam, Ellicott City, MD (US); Omid Athari, Cockeysville, MD (US)

(73) Assignee: Sick, Inc.

(21) Appl. No.: 12/884,911

(22) Filed: Sep. 17, 2010

Related U.S. Application Data
(60) Provisional application No. 61/262,752, filed on Nov. 19, 2009.

(51) Int. Cl. B65G 59/04

(52) U.S. Cl. 414/797; 414/801

(57) ABSTRACT

Systems, apparatuses, methods, and computer program products for item handling, including in-feeding and individually out-feeding of items, such as pieces of mail, parcels, or articles of manufacture. Destacking each successive leading item, individually, in a stack or series of items by automatically adapting, in real time, to varying item presentment conditions. Each successive leading item can be moved and output without unwanted or unacceptable movement of any following item or items, by selective activation of components to move and/or assist with moving the leading item for output therefrom. Selective activation can be based on presentment information associated with each leading item in the stack or series, and the leading item can be output after a series of controlled movements thereof.

### CROSS-REFERENCE TO RELATED APPLICATION

This application claims the benefit of U.S. Provisional Application No. 61/262,752 filed Nov. 19, 2009, the entire content of which is hereby incorporated by reference into the present application.

### STATEMENT REGARDING FEDERALLY SPONSORED RESEARCH OR DEVELOPMENT

A portion of one or more inventions herein described was made in the course of or under a contract or subcontract thereunder with the United States Postal Service, Contract #3AAFLT-09-B-0005.

### FIELD

The disclosed subject matter relates generally to item handling. In particular, the disclosed subject matter relates to out-feeding of items, such as pieces of mail, parcels, or articles of manufacture. Aspects of the disclosed subject matter also relate to in-feeding of such items.

### SUMMARY

Various embodiments of the disclosed subject matter can include a multi-staged destacking apparatus for continuously and sequentially destacking mail items in a stack, the apparatus eliminating or reducing substantially simultaneous output of multiple mail items without unwanted or unacceptable movement of one or more following mail items. The apparatus can comprise: a first stage of components configured to move in an out-feed direction a leading mail item in the stack of mail items; a second stage of components configured to move the leading mail item in the out-feed direction; a third stage of components configured to move the leading mail item in the out-feed direction; a first vacuum portion; a second vacuum portion; a first mail item presence sensor; and a second mail item presence sensor. Each of said first, second, and third stages of components can include a friction belt portion, a third vacuum portion, and a sensor that senses one of position and movement. Further, the first, second, and third stages can be operative to be selectively activated based on presentment information associated with the leading mail item. The presentment information may include one or more of position information of the leading mail item, movement information of the leading mail item, transition information from the leading mail item to the immediately following item, leading edge information regarding the leading item, trailing edge information regarding the leading item, leading edge information regarding one or more following items, trailing edge information regarding one or more following items, and position information of one or more following mail items, and the presentment information can be obtained using one or more of said sensors, including the first mail item presence sensor, the second mail item presence sensor, and the sensors that sense one of position and movement. In a front view, the first vacuum portion and the first mail item presence sensor may be positioned between the first and second stages of components and the second vacuum portion and the second mail item presence sensor may be between the second and third stages of components. The first and second vacuum portions can be operative to be on at all times during the continuous and sequential destacking by the multi-staged destacking apparatus.

Optionally, the mail items can be pieces of mail including at least one letter, at least one flat, or at least one letter and at least one flat. In various embodiments, the stack may be neither sorted, nor justified, nor groomed. Optionally, some or all of the mail items of the stack may not match in size, dimension, or type with respect to one or more other mail items of the stack. Optionally, a vacuum of each of the first and second vacuum portions may be less than a vacuum of each of the second vacuum portions of the first, second, and third stages, respectively. In various embodiments, the sensor of each of said first, second, and third stages of components can be a wheeled encoder. In various embodiments, the first mail item presence sensor can be arranged in overlapping fashion with the first vacuum portion from the front view, the second mail item presence sensor can be arranged in overlapping fashion with the second vacuum portion from the front view, and each of said friction belts can be arranged in overlapping fashion with respect to corresponding third vacuum portions from the front view.

Various embodiments of the disclosed subject matter also can include a method for receiving a plurality of items in series in a first format and outputting items in a second format in the same order as the received series, the method comprising: receiving the series of items in the first format, the series of items including a first item and a plurality of successive items; automatically and continuously detecting at least one of presence, position, movement, and transition information associated with the first item while the first item is still in the first format; automatically moving the first item in response to said automatically and continuously detecting, said moving including staged movement of the first item without unwanted or unnecessary movement of any of the successive items; after said moving the first item, automatically outputting only the first item in the second format; and continuously repeating said automatically detecting, moving, and outputting for each next first item in the series of said items.

Optionally, some or all of the items may be unsorted, unjustified, or ungroomed, and some or all of the items do not match in size, dimension, or type with respect to other of said items. In various embodiments, the first format may be a stack in a thickness direction of the items and the second format may be generally single file in a length direction of the items. In various embodiments, the staged moving can include more than one stage. Further, in various embodiments, the staged moving may include multiple, distinct movements of the first item prior to said outputting. Optionally, the items may be pieces of mail including at least one letter, at least one flat, or at least one letter and at least one flat. In various embodiments, the method can further comprise detecting a force or a pressure associated with the series of items with the first item in the first format; and determining whether to modify the force or pressure associated with the series of items, and modifying the force or pressure if it is determined that the force or pressure is to be modified, otherwise not modifying the force or pressure.

Various embodiments of the disclosed subject matter can additional include a system for continuously and substantially in sequence destacking articles sequentially arranged in a stack, wherein the system comprises: means for in-feeding the stack of articles; means for selectively moving a leading article in the stack in one or more sequential movements without unwanted or unacceptable movement of one or more following articles, said means for selectively moving continuously attempting to detect a presence of the leading article and adapting a destacking movement sequence for the leading article based on results of its presence detection attempts; and means for outputting only the selectively moved leading article.

In various embodiments, the system can further comprise a force or pressure modifying means for adjusting a force or pressure associated with the stack of articles, the modifying being based on a force or pressure measurement associated with said means for selectively moving, and said means for selectively moving can be a staged-destacker having a plurality of friction elements, plurality of vacuum elements, and a plurality of sensors, the friction elements and a portion of the vacuum elements being selectively activated to move the leading item, based on inputs received from one or more of the sensors. Optionally, the articles may be pieces of mail, each said piece of mail being one of a letter or a flat. Further, optionally, the articles may be substantially uniform in size and shape.

Various embodiments also include a nontransitory computer readable storage medium having stored thereon software instructions that, when executed by a processor, cause the processor to perform operations comprising: receiving automatically and continuously detected data regarding at least one of presence, position, movement, and transition information associated with at least one of a leading item and one or more following items in a stack of items; adapting a staged movement sequence for the leading item based on said receiving; and automatically outputting instructions to cause staged movement of the leading item in the stack in correspondence with the adapted staged movement sequence without unwanted or unacceptable movement of any of the following items.

In various embodiments, the software instructions of the nontransitory computer readable storage medium, when executed by the processor, further cause the processor to perform the following operations comprising: receiving detected data regarding a force or a pressure associated with the stack of items; and determining whether to modify the force or pressure associated with the stack of items, and outputting instructions to modify the force or pressure if it is determined that the force or pressure is to be modified.

Various embodiments can include an apparatus configured substantially to eliminate or reduce substantially simultaneous output of multiple items therefrom, an apparatus according to various embodiments of the disclosed subject matter can comprise means for outputting only a leading item at a time, without unwanted or unacceptable movement of a following item or items, and/or an apparatus configured to output a plurality of items in sequence. Further, the item or items may be unsorted and may not match in size, dimension, and/or type some or all of other items. Optionally, the item or items are pieces of mail. Optionally, each piece of mail may be one of a letter or a flat. In various embodiments, in-feeding and corresponding out-feeding of the item or items adheres substantially to first-in-first-out format. In various embodiments, the apparatus may be a staged-destacker. Optionally, the apparatus can be comprised of a plurality of stages configured to be selectively activated to move leading items. In various embodiments, one or more of the stages is selectively activated base on presentment information associated with the leading item. Presentment information can include one or more of position information of the leading item, movement information of the leading item, transition information from the leading item to the next immediate item, position information of one or more of the following items, trailing edge information regarding the leading item, trailing edge information regarding the one or more of the following items, and force or pressure information associated with the plurality of items. In various embodiments, the presentment information can be obtained using one or more sensors. Optionally, at least one of the one or more sensors is a wheeled encoder.

Various embodiments of the disclosed subject matter can additionally include a system for continuously destacking, in sequence, items sequentially arranged, the system comprising means for selectively moving a first, leading item in the sequence without unwanted or unnecessary movement of any following items. The system can further comprise a feeder and an out-feed transfer, the feeder supplying a sequence of items, in single file, to the means for selectively moving. Further, in various embodiments the system can also be comprised of a force or pressure modifying means for adjusting a force or pressure associated with the sequence of items, the modifying being based on a force or pressure measurement associated with the means for selectively moving. Optionally, the items can be pieces of mail, wherein each said piece of mail can be one of a letter or a flat. Optionally, the items can be ungroomed and the leading item may not match in size, dimension, and/or type some or all of following items. In various embodiments, in-feeding and corresponding out-feeding of the items adheres substantially to first-in-first-out format. Further, in various embodiments, the means for selectively moving may be a staged-destacker having a plurality of friction elements, and plurality of vacuum elements, and a plurality of sensors, the friction elements and a portion of the vacuum elements being selectively activated to move the leading item, based on inputs received from one or more of the sensors. The means for selectively moving continuously may attempt to detect a presence of the leading item and adapts a destacking movement sequence for the leading item based on results of its presence detection attempts. Optionally, the selective movement of the first item can be controlled by a controller.

Various embodiments of the disclosed subject matter also may include a system comprising means for selectively moving leading item without unwanted or unacceptable movement of one or more following items, the system comprising: first detection means for detecting a presence of the leading item; second detection means for detecting movement of the leading item; first moving means for moving the leading item, the first moving means being configured to be selectively activated; second moving means for moving the leading item, the second moving means configured to be selectively activated, wherein each of the first and second moving means are selectively activated to selectively move the leading item. The system can further comprise first vacuum means for providing a first vacuum; second vacuum means for providing a second vacuum; third vacuum means for providing a third vacuum, wherein the first vacuum means and the second vacuum means are configured to be selectively activated. Optionally, respective first and second vacuums are is greater than the third vacuum.

Various embodiments of the disclosed subject matter also can include a method substantially to eliminate or reduce substantially simultaneous output of multiple items, a method for outputting only a leading item at a time, without unwanted or unacceptable movement of a following item or items, and/or a method for outputting a plurality of items in sequence. In various embodiments, the methods can further comprise outputting the leading item and repeating said automatically detecting and selectively moving the next leading item without unwanted or unnecessary movement of any following items. Optionally, the item or items may be pieces of mail, each said piece of mail is one of a letter or a flat, the items or items may be unsorted and/or ungroommed, and the item or items may not match in size, dimension, and/or type some or all of other items. In various embodiments, in-feeding and corresponding out-feeding of the item or items adheres substantially to first-in-first-out format.

Various embodiments can further include a method for continuously destacking, in sequence, items sequentially arranged, the method comprising automatically detecting presence of a leading item and selectively moving the leading item without unwanted or unnecessary movement of any following items. In various embodiments, the selective moving can be based on the detected presence of the leading item. Further, in various embodiments, the detected presence of the leading item may include at least one of position information of the leading item and movement information of the leading item, and transition information for the leading item with respect to the next immediate item.

Various embodiments of the disclosed subject matter also can include a method comprising: receiving a leading item in a stack of items; determining at least one of a presence, position, movement, and transition information associated with the leading item; selectively moving the leading item; and outputting only the leading item. The selective moving may include movement of the leading item in one or more stages. Additionally, optionally the selective moving may include multiple, distinct movements of the leading item prior to outputting.

Various embodiments of the disclosed subject matter also can include a system for detecting and modifying force or pressure of a stack of items for a destacking application and a method for detecting and modifying force or pressure of a sequential stack of items, respectively

Additionally, various embodiments of the disclosed subject matter can include a system for automatically detecting and adjusting an amount of force or pressure of a stack of items presented for destacking, the system comprising means for automatically detecting an amount of force or pressure of a stack of items presented for destacking; and means for adjusting the amount of force or pressure of the stack based on said detection, wherein the detecting and adjusting are performed substantially in real time. The detecting may include detecting a movement of a mechanical apparatus associated with an item movement sensing means for sensing movement of a leading item of the stack.

### BRIEF DESCRIPTION OF THE DRAWINGS

The accompanying drawings illustrate embodiments of the disclosed subject matter. The disclosed subject matter will be best understood by reading the ensuing specification in conjunction with the drawing figures, in which like elements are designated by like reference numerals. As used herein, various embodiments can mean some or all embodiments.

FIG. 1 is a functional block diagram of a system according to various embodiments of the disclosed subject matter;

FIG. 2 is an overhead, front, and side perspective view of an apparatus according to various embodiments of the disclosed subject matter;

FIG. 3 is an overhead generally rear of a system including the apparatus shown in FIG. 2, according to various embodiments of the disclosed subject matter;

FIG. 4 is shows a partial front view of the apparatus shown in FIG. 2;

FIG. 5 is a flow chart of a method according to various embodiments of the disclosed subject matter;

FIG. 6 is a flow chart of a method according to various embodiments of the disclosed subject matter;

FIG. 7 is a diagram representation for staged destacking of items arranged according to a first scenario;

FIG. 8 is a diagram representation for staged destacking of items arranged according to a second scenario;

FIG. 9 is a diagram representation for staged destacking of items arranged according to a third scenario; and

FIGS. 10A and 10B show a portion of a system for sensing or detecting an amount of force or pressure associated with items presented for destacking or picking off according to various embodiments of the disclosed subject matter.

### DETAILED DESCRIPTION

Various embodiments of the disclosed subject matter are directed generally to systems, apparatuses, methods, and computer program products for item handling, including in-feeding and individually out-feeding, for example, items, such as pieces of mail, parcels, or articles of manufacture. Various embodiments of the disclosed subject matter can reduce or eliminate occurrence of multiple items being output at a time and/or items being output out of sequence. Various embodiments also are directed to sensing or detecting an amount of pressure or force associated with the items presented for out-feeding and modifying or adjusting the pressure or force accordingly.

Various embodiments of the disclosed subject matter include systems, apparatuses, methods, and computer program products that can or can cause individual and in-sequence “picking off” or “destacking” of successive leading items in a stack or series of items, by correctly determining appropriate components to activate and selectively activating and/or deactivating said components based on presentment information associated with each of the successive leading items in the stack or series. In various embodiments, activation can include moving one or more dynamic components to move the leading item in an output direction. In various embodiments, activation also can include pulling on or otherwise holding the first item so that it is against the dynamic component or components. Incidentally, though the term “destacking” is used, the items are not necessarily placed in an unstacked format after being destacked. Thus, in various embodiments, the destacked items may be “destacked” to another stack or stacks, for example.

As used herein, the term leading item can mean an item in a stack or series of items that is at the front of the stack or series of items to be destacked. As the leading item is destacked, the next item in line becomes the “new” leading item for destacking. Additionally, presentment or presenting information, as used herein, can include one or more of the following: positioning information associated with the leading item, movement information associated with the leading item, transitions between the leading item and the next item in sequence, positioning information associated with one or more following items, leading edge information of the leading item, trailing edge information of the leading item, leading edge information regarding one or more following items, trailing edge information regarding one or more of the following items, and/or force or pressure information associated with items presented for destacking or picking off. Further, presentation conditions of each leading item and its following items may be unique and/or varying.

In various embodiments, the leading item can be moved in a plurality of stages, in an output direction, by selectively activating components (dynamic and otherwise) of a destacker associated with a particular stage of movement. Likewise, components not associated with leading item movement during a particular stage may be selectively deactivated. In various embodiments, some components may remain on at all times of operation. Activation and/or deactivation can be full or partial. Thus, systems, apparatuses, methods, and computer program products according to various embodiments of the disclosed subject matter can successively destack in proper order each leading item of a series of successive leading items, individually, by automatically adapting, in real time, to varying or continuous item presentment conditions.

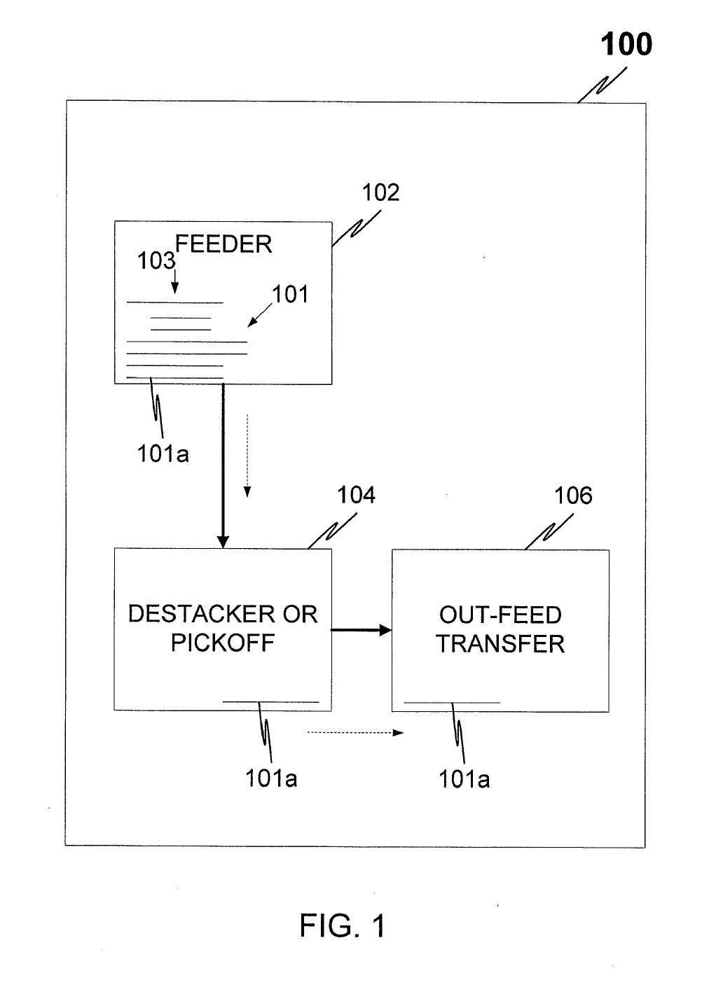

Various embodiments of the disclosed subject matter can handle items of the same size, shape, or type and/or of mixed or varying sizes, shapes, or types. For example, various embodiments can handle flat mail or mixed mail (which is a broader range of flat mail sizes or the combination of flat and letter mail) in a single, consolidated stream. The item stream to be output or fed out (i.e., “destacked” or “picked off”) can be comprised of a single file of items, stacked such that each item, except the last item in the stack, is in contact with at least the immediately following item in the stack. Each following item also can be in contact with the immediately preceding item as well. In some instances, an item may contact one or more items not immediately preceding or following it, such as an item separated, in part, by the immediately preceding or following item. See, for example, stack 101 in FIG. 1, where 101a can represent the leading item and the items shown in the figure above leading item 101a can represent following items.

The stack of items for feeding out can be oriented horizontally, vertically, or at another angle with respect to a working or destacking surface of an apparatus for destacking the items. The orientation of the stack of items can be based on the orientation or configuration of the apparatus for destacking and/or based on the orientation and configuration of an apparatus for feeding the stacked items to the apparatus for destacking the items. Moreover, some or all of the items in the stack can be in an “ungroomed” state prior to being destacked or picked off. For example, the items in the stack may be unjustified (e.g., with respect to a back ledge of a feeder table), skewed, elevated, or a combination thereof. Note, for example, that some items in the stack 101 in FIG. 1 are shown in an ungroomed state. Moreover, some items in the stack 101 are shown with dissimilar dimensions. Optionally, the items in the stack can be groomed and/or of the same type or size.

FIG. 1 shows a functional block diagram of a system 100 for handling items according to various embodiments. Items to be handled by system 100 can be substantially as described above. FIG. 1 shows a stack of items 101, including leading item 101a. The dashed arrows in FIG. 1 show a general flow of leading item 101a through the system 100.

Generally speaking, system 100 can be configured as a dynamic and adaptive, destacking or pick-off system that can pick off for output thereof a first, leading item of a stack or series of items, without “unwanted” or “unacceptable” movement of any following item or items. Put another way, system 100 can be configured to pick off only a leading item from a stack or series of items by correctly determining which components thereof to activate and/or deactivate and activating and/or deactivating said components, selectively. In various embodiments, system 100 can destack each first item by moving the item, in an output direction, in stages. Such staged movement can be accomplished by selectively activating components (dynamic and otherwise) associated with a particular stage of movement. Likewise, components not associated with leading item movement during a particular stage may be selectively deactivated, or activated to prevent movement of one or more successive items in the stack or series. In various embodiments, some components may remain on at all times of operation. Activation and/or deactivation can be full or partial. Thus, systems, apparatuses, methods, and computer program products according to various embodiments of the disclosed subject matter can destack each of a series of successive leading items, individually, by automatically adapting, in real time, to varying and/or consistent item presentment conditions.

During system operation, one or more following items may move as the leading item is destacked and output from system 100. “Unwanted” or “unacceptable” movement of one or more following items may lead to a multiple pick-off situation, an out-of-sequence situation, and/or a jam situation, for example. Thus, various embodiments of the disclosed subject matter reduce or eliminate such unwanted or unacceptable movement of one or more following items and output only the leading item. Of course, once the leading item is picked off and output from the system 100, any following item or items would move toward presentation for destacking (i.e., general movement in the direction of the stack toward a destacker, for example), with the next item in line now becoming the leading item.

System 100 can be configured to dynamically react to presentation conditions associated with each individual item, as each item presents itself as the leading item. Presentation of items can be substantially continuous and system 100 can continuously react in “real time” to actual item presentation conditions, such as, but not limited to location, orientation, movement, transition, edge, force, pressure, etc. associated with the leading item and/or one or more following items. Such presentation conditions can be unique and/or varying for items successively presented as the leading item, and system 100 can automatically adapt to various presentation conditions.

In various embodiments, system 100 can continually sense and detect presentment information associated with each leading item (which may include information associated with one or more following items). As noted above, presentment information can include, for example, one or more of positioning information associated with the leading item, movement information associated with the leading item, transitions between the leading item and the next item in sequence, leading edge information of the leading items, trailing edge information of the leading item, leading edge information associated with one or more of following items, and/or trailing edge information associated with the one or more following items. Optionally or alternatively, in various embodiments, presentment information can include positioning information associated with one or more following items. Optionally or alternatively, in various embodiments, presentment information can include force or pressure information associated with items presented for destacking or picking off. Accordingly, movement of the leading item can be done accurately and in a controlled manner, with only the leading item being moved for outputting from the system 100 based on the sensing or detecting of the aforementioned presentment information. As indicated previously, one or more of the following items may move, but are prevented from being output with the leading item.

In response to presentment information sensed by system 100, specific components (e.g., associated with a particular movement stage of the leading item) of system 100 can be caused to activate (or deactivate). In various embodiments, activation can be selective and can include instructing and causing selective movement of one or more dynamic (e.g., moveable) component associated with each activated section. Movement of the dynamic components can cause the leading item to move without unwanted or unacceptable moving of any following items, and movement of the leading item can be sensed to determine if further activation and corresponding movement are necessary. In various embodiments, activation also can include activation of at least one item holding component, such as a vacuum component.

Dynamic and holding components can be arranged in sections, with each section having at least one dynamic component and/or at least one holding component. In various embodiments, each section can have at least one dynamic component and at least one holding component. Furthermore, system 100 can have one or more sections (e.g., two, three, four or more), and components of each section can be activated or “fired” accordingly, based on presentation information associated with the leading item. In various embodiments, such activation can be to only activate a particular section or sections (e.g., activation of one or more components per section). In various embodiments, dynamic components of a section or sections which are determined to be adjacent the leading item can be activated. Activation of one or more sections (and components therein) can be simultaneous or successive. Accordingly, movement of the leading item may be by way of a series of controlled or staged movements. Of course, depending upon the position and/or movement of the leading item, for example, it may be necessary only to activate one section and thus move the leading item only once to destack the leading item.

In various embodiments, if the leading item is not detected for a particular section, then some or all of the components associated with that particular section may not be activated or may be deactivated. As such, any following items that may be adjacent the non-activated section or sections may not be moved (e.g., in an unwanted or unacceptable manner). Such staged activation of sections may thereby reduce or eliminate an amount of contact and/or movement force applied to following items in order to move and thus destack only the leading item.

After a “first” leading item is successfully destacked, system 100 can continue to receive items sequentially and adaptively destack each “new” leading item based on detected presentation information associated with this new leading item.

As can be seen in FIG. 1, system 100 can include a feeder 102, a destacker or pickoff 104, and an out-feed transfer 106. As noted earlier, FIG. 1 shows a stack of items 101, including leading item 101a. The dashed arrows in FIG. 1 show a general flow of each leading item 101a through the system 100. As shown, items can be fed from feeder 102 to destacker 104, and then output from destacker 104 to out-feed transfer 106.

Items can be picked off from destacker 104 at any suitable rate, such as, but not limited to, 2.2 items per second. Not explicitly shown, items can be output from out-feed transfer 106 to any suitable system or subsystem for item processing, such as a sensor for sensing multiple outputs, a sorter, a router, a bin, another stack, a reader, etc. Similarly, items can be fed or received by feeder 102 by any suitable system, subsystem, or apparatus. Though shown as three separate units, in various embodiments, some or all of these elements may be considered to be essentially part of one another. For example, the destacker 104 and out-feed transfer 106 may be considered together as the destacker 104.

Generally, items to be destacked can be arranged sequentially in feeder 102, as described above, and fed to destacker 104. Feeder 102 can be any suitable apparatus for supplying items to destacker 104. For example, feeder 102 can comprise a smooth, flat surface upon which items can slide, such as a feeder table. Optionally, feeder 102 can comprise a conveyor belt that supplies items to destacker 104. Feeder 102 can be of any suitable orientation. For example, feeder 102 can be configured and oriented such that the items thereon are sequentially arranged horizontally, vertically, or at some other angle with respect to a working surface of the destacker 104 (e.g., presentation wall thereof) for feeding to destacker 104. In various embodiments, the orientation and/or configuration of the feeder 102 can be based on the dimensions and/or type of items. The orientation and/or configuration of feeder 102 also may be based on a particular configuration of the destacker 104. Note, however, that the destacker 104 can be configured to be compatible with any suitable feeder.

In various embodiments, items in feeder 102 can be forced toward and against destacker 104. In various embodiments, the leading item and/or one or more following items can be forced against a presentation wall of destacker 104. Such force can be provided by gravity and/or the weight of the items, for example, in the case of a feeder 102 configured with the items arranged vertically or at an angle. Optionally, feeder 102 can include a biasing apparatus 103 that applies a pressure or a force to the items for supplying to destacker 104, such as a paddle, a plate, or a pushrod pushing against an end-most item in the feeder. In various embodiments, the force or pressure of the items at the destacker 104 can be sensed or measured. In various embodiments, and as will be discussed below, the force or pressure of the items at the destacker 104 can be measured or sensed at the destacker 104, by the destacker 104. The force or pressure at the destacker 104 created by the items can be modified, for example, to reduce an overpressure at a pickoff position of the destacker 104, such as at the presentation wall. In various embodiments, the force or pressure can be modified, for example increased or decreased, based on feedback of the measured or sensed pressure or force. For example, biasing apparatus 103 may be caused to move accordingly to increase or decrease an amount of force or pressure of the items at the destacker 104.

Destacker or pickoff 104 can be configured to ensure proper output sequencing of items fed thereto. Destacker 104 also can be configured to pick off only a leading item from a stack or series of items, without causing unwanted or unacceptable movement of any following item or items. In various embodiments, destacker 104 can operate to automatically and adaptively sense presentment information of consecutively presented leading items and move each leading item, individually, in response to its particular presentment situation. In various embodiments, destacker 104 can include a plurality of sections and portions of each section can be turned on and off in response to sensed presentation information associated with the current leading item to move the current leading item. As such, the leading item can be moved in stages based on section operation prior to being output from destacker.

Destacker 104 can have any suitable number of sections, such as two, three, or four or more. The number of sections can be based on the size or type of items to be destacked. Moreover, in various embodiments, the destacker 104 can be modular and reconfigurable in the sense that one or more sections can be added or removed, depending upon the application. Furthermore, each section may be different in its component number and configuration (e.g., dynamic components and non-dynamic components).

Destacker 104 can include a plurality of dynamic components, such as friction belts, friction rollers, or friction cylinders. As noted above, one or more dynamic components can be associated with each destacker section. Dynamic components can be configured to be activated such that they move and in turn move the leading item presented thereagainst. In various embodiments the leading item will be pulled against one or more dynamic components. Activation and thus movement of the dynamic components can be selective, based on sensed presentment information associated with the leading item. Moreover, the leading item may be pulled against one or more dynamic components based on sensed presentment information associated with the leading item. Optionally, one or more dynamic components associated with one or more non-leading items may be activated or deactivated so as to move corresponding non-leading items slightly in a direction opposite the outputting direction or to prevent or substantially prevent the one or more non-leading items from unwanted or unacceptable movement. In various embodiments, deactivation of a dynamic component can mean that the component is prevented from moving, even if a force associated with an item tries to cause it to move. Thus, deactivation can mean that the dynamic component is controlled so as to prevent movement thereof.

Each dynamic component can have one or more moveable elements. For example, each dynamic component can have one or more friction belts, one or more rollers, one or more cylinders, or combination thereof. In various embodiments, dynamic portions can be at a presentation wall or front face of destacker 104.

Destacker 104 also can include a plurality of holding components, such as vacuum elements. The holding components can be configured to “grab” and/or hold the leading item against the presentation wall of the destacker 104, for example. In the case of vacuum elements, a portion of the vacuum elements can be turned on and off based on presentation information associated with the leading item currently being presented at the presentation wall. Optionally, a portion of the vacuum elements can remain on during movement and destacking of the leading item. In various embodiments, vacuum elements that are turned on and off can generate a higher vacuum than can the vacuum elements that remain on at all times of destacker 104 operation. In various embodiments, the holding components can be at the front face of the presentation wall of the destacker 104. Some vacuum elements, such as vacuum elements that can be selectively turned on and off during destacker operation, may be arranged such that they are disposed adjacent to or in overlapping fashion with respect to one or more dynamic components. For example, each dynamic component may have associated with it one vacuum element, and they can be arranged either adjacent to or in overlapping fashion. In the case of adjacent and/or overlapping, the dynamic component can have access portions, such as holes, that allow access to the first item by a vacuum associated with the corresponding vacuum element. Such access may be through the presentation wall of the destacker.

Destacker 104 can further include a plurality of sensors to detect item presence and/or movement of items, such as the leading item. Optionally or alternatively, one or more of the sensors can be configured to detect a transition from a leading item to a next successive following item or leading and/or trailing edge information, for example. In various embodiments, the sensors can be at the front face of the presentation wall of the destacker 104. Analysis of one or more of the sensor's outputs can be used to determine the location of the leading or following items. Analysis of one or more of the sensor's outputs can be used to determine movement of the leading item, for example. Optionally, the sensing can detect “leading to next-following item transition,” or leading and/or trailing edge information, as noted above. Destacker 104 also can include one or more sensors to sense or otherwise determine a force or pressure of the stack of items applied at the destacker 104, such as at the working surface of the destacker 104 (i.e., the front face of the presentation wall of the destacker).

Any suitable sensors can be used to detect item presence and/or movement of items (i.e., presentment information). Furthermore, any suitable number or configuration (i.e., location and/or type) of sensors can be implemented to detect item presence and/or movement of items.

In various embodiments, destacker 104 can include a plurality of sensors that detect item movement. Such item movement can be with respect to an outputting direction of the destacker 104. Destacker 104 also can include a plurality of sensors that detect item presence or position, such as presence or position of the leading item. For example, wheel encoders, optical displacement sensors, three-dimensional vision sensors, etc. or combination thereof can be used. In various embodiments, sensors that sense movement of the leading item may be designated as intelligent sensors, and sensors that sense position may be designated as mail present sensors. In various embodiments, sensors that detect movement of the leading item can be in direct contact with the leading item, such as the wheeled encoders discussed above. In various embodiments, sensors that detect presence or position of the leading item can be “straight ahead” sensors.

As noted above, destacker 104 can include one or more sensors or detectors to sense or detect a force or a pressure of items presented for destacking or picking off. Force or pressure can be sensed, detected, or otherwise determined directly or indirectly. For example, such force or pressure sensors can detect an amount of movement of a carriage associated with the aforementioned sensors for sensing leading item movement, wherein when the stack of items pushes on the item movement sensors, the item movement sensors and their carriage move an amount based on the pressure or force of the stack, and the amount of movement is sensed and correlated to the pressure or force of the stack.

Out-feed transfer 106 can be any suitable apparatus configured to receive items from destacker 104 and output therefrom items received from destacker 104. For example, out-feed transfer 106 can be a set of pinch wheels cooperatively rotating such that an item “pinched” therebetween is accelerated and output therefrom. As indicated earlier, items can be output from out-feed transfer 106 to any suitable system or subsystem for item processing, such as a sensor (e.g., sensor for detecting multiple outputs), a sorter, a router, a bin, another stack, a reader, etc. Note, also, that out-feed transfer 106 may be considered part of destacker 104.

System 100 also can include one or more controllers (not explicitly shown) to control feeder 102, destacker 104, and/or out-feed transfer 106. Each of the one or more controllers can be any suitable controller including, but not limited to a computer, a microcomputer, a microcontroller, a processor, or the like. In various embodiments, one controller may control feeder 102, destacker 104, and out-feed transfer 106, or each of the foregoing system components can have its own controller, working either separate or together with one or more of the other controllers. For example, a master-slave arrangement may be implemented. In various embodiments, destacker 104 can operate independently of other item handling systems or subsystems, such as a sorter control system, arranged downstream and/or upstream thereof. Similarly, in various embodiments, feeder 102 and/or out-feed transfer 106 can operate independently of other item handling systems or subsystems (including destacker 104) arranged downstream and/or upstream thereof.

In addition, the one or more controllers may operate in response to instructions recorded on a computer or processor readable storage medium and executed by the one or more controllers. Such instructions may be written in any suitable programming language, such as C, C++, Java™ Visual Basic, or any object-oriented programming language. However, the programming language is not limited to being object-oriented and can be non-object-oriented (e.g., assembly language, BASIC, etc.) or by combination of object- and non-object-oriented languages.

System 100 also can include a storage unit (not explicitly shown) in the form of a computer or processor readable storage medium. The storage unit may be any suitable storage apparatus, including, but not limited to, a hard disk drive, a removable disk drive, ROM, RAM, EEPROM, PROM, flash memory, etc. The storage unit can store instructions for operation of the controller or a processor. The storage unit also may be used to store data of system operation, such as historical information (e.g., data collected over a certain time period, an in-feed rate, an out-feed rate, a number of multiple articles sent at once, a percentage of multiple articles sent at once, occurrences of jams, out-of-sequence data, etc.). Data from the storage unit can be output therefrom for any suitable purpose, such as for display on a monitor or for generation of a report.

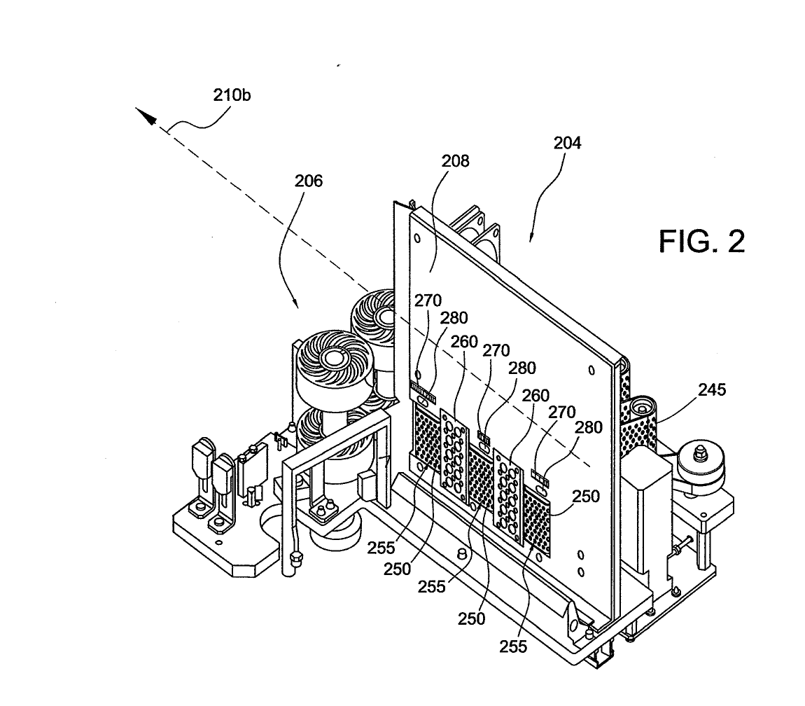

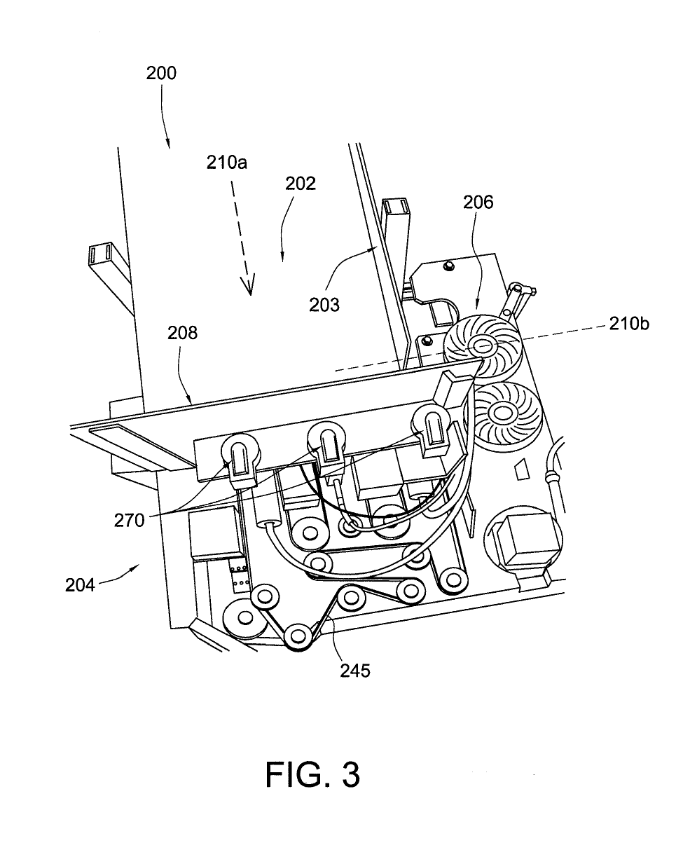

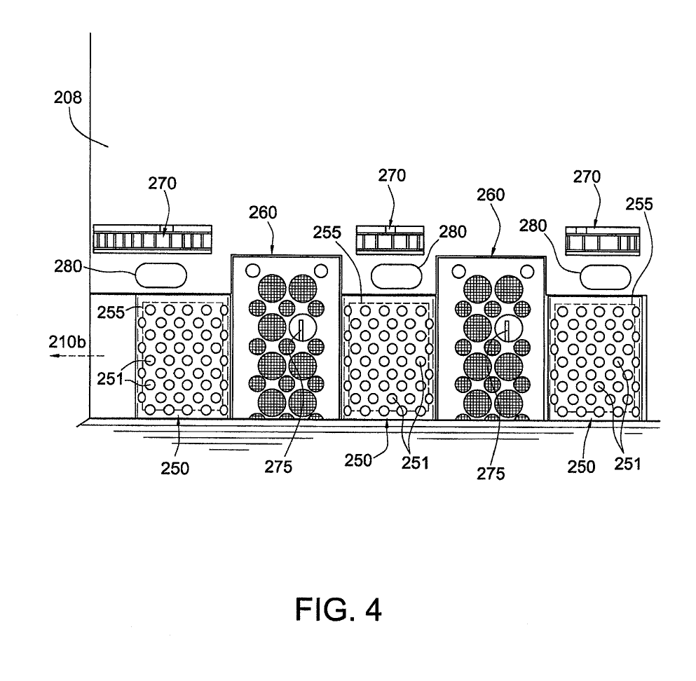

FIGS. 2-4 show a destacker 204 of a system 200 according to various embodiments of the disclosed subject matter, with FIG. 2 showing an overhead, front, and side perspective view, with FIG. 3 showing an overhead generally rear view, and with FIG. 4 showing a partial front view. FIG. 2 also shows an out-feed transfer 206 according to various embodiments, and FIG. 3 also shows out-feed transfer 206 and feeder 202 according to various embodiments. In various embodiments, the destacker 204 shown in FIGS. 2-4 can be a modification of an existing sorting feeder. For example, various embodiments of the disclosed subject matter can encompass retrofitting or modifying any sorter, destacker, or the like, to arrive at a destacker substantially as described herein, and which functions and operates substantially as described herein. Furthermore, destacker 204 according to various embodiments of the disclosed subject matter is not limited to being a modification of any one specific sorter, destacker, or the like.

Destacker 204 can include one or more dynamic components and one or more holding components. Each dynamic component can include a moving portion or portions, or a portion or portions that can cause a leading item to move toward in an out-feed direction. Destacker 204 shown in FIGS. 2-4 includes as dynamic components friction belt portions 250. Corresponding to each friction belt portion 250 may be a holding component in the form of a switched vacuum point or chamber 255. Note in particular that each switched vacuum chamber 255 may be located adjacent to (e.g., behind) its corresponding friction belt portion 250, in a general coaxial or overlapping arrangement. See, for example, the dashed lines in FIG. 4. Furthermore, each friction belt portion 250 and switched vacuum chamber 255 can be arranged at or substantially at a front face 208 of the presentation wall. Each friction belt portion 250 can have a plurality of apertures 251 to allow for the vacuum chamber to take action against items presented at the destacker 204 for destacking. The foregoing dynamic and holding components can be viewed in terms of sections, with each section including a dynamic component in the form of the friction belt portion 250 and a holding component in the form of the switched vacuum point or chamber 255. Incidentally, though FIG. 3 shows belt 245 being one belt and thus belt portions 250 are comprised of portions of the belt 245 associated with corresponding switched vacuum chambers 255 and/or at or substantially at the front face 208 of the presentation wall, various embodiments can include individual belts, which can be separately controlled and drivable.

Destacker 204 also can include one or more holding components in the form of center vacuum points or chambers 260. Center vacuum chambers 260 also are arranged at or substantially at the front face 208 of the presentation wall, with each center vacuum chamber 260 having a combination friction belt portion/switched vacuum chamber arranged on each side thereof, for example. A vacuum can be created by holding component such that the vacuum acts on the front face of vacuum chamber 260, at or substantially at the front face 208 of the presentation wall.

The switched vacuum chambers 255 can be switched on and off based on presentment information sensed by various sensors of the destacker 204. Thus, each switched vacuum chamber 255 can be selectively activated (i.e., switched on) to pull a leading item against its corresponding friction belt portion 250. Center vacuum chambers 260 can remain on at all times during operation. Optionally, the center vacuum chambers 260 may be turned on and/off based upon presentment information. In various embodiments, the center vacuum chambers 260 can have a lower vacuum than the vacuums of the switched vacuum chambers. Center vacuum chambers 260 can assist with holding the leading item against or substantially against the friction belts and/or the front face 208 of the presentation wall as the leading item is moved in the outputting direction based on selective activation of the destacker 204 sections. Dashed arrow 210b shows the general outputting direction for outputting leading items. A leading item can be presented at the front face 208 of the presentation wall, then moved in a controlled manner along dashed arrow 210b based on sensed presentation information associated with leading item, then output toward and through out-feed transfer 206. A general direction of the stack toward the front face 208 of the destacker 204 can be seen in FIG. 3 as dashed arrow 210a. Some or all of items can be justified or unjustified with respect to ledge 203 and/or an optional opposite ledge (not shown) of feeder 202.

Destacker 204 can include one or more intelligent sensors, such as encoders 270 (e.g., wheeled encoders) to sense presentment information of the leading item and otherwise, substantially as described above. Though wheeled encoders are shown in FIGS. 2-4, such presentment sensing can be accomplished using other sensors or other sensing techniques, such as distance measurement, laser, photoelectronics, etc. Further, though encoders 270 are shown in FIGS. 2 and 4 as being above belt portions 250, each of the encoders 270 (or other intelligent sensors) can be positioned at any suitable position, such as between belt portion 250 and sensor 280, within switched vacuum chamber 255, or below belt portion 250 (in which case belt portion 250 would be raised a bit so the encoder could be in contact with presented items). Optionally or alternatively, encoders 270 may be inside each center vacuum chamber 260. Placement of the encoders 270, such as lower than shown in FIGS. 2 and 4, such that they are closer to the base of the items to be destacked may improve contact between the leading item and/or one or more following items, thereby providing more reliable presentment information and other information regarding movement of the leading item and/or one or more of the following items.

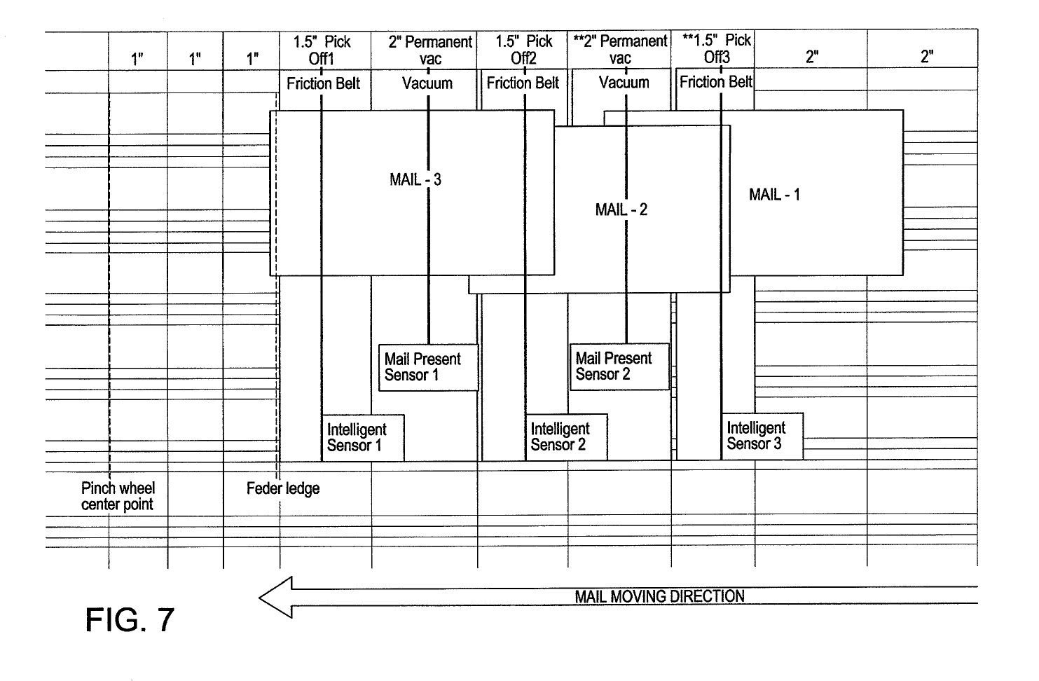

Destacker 204 can also include one or more sensors that sense presentment information in the form of position only. In various embodiments, such sensors can sense that an item is directly or substantially directly in front of it on the front face of the destacker 204. Such sensors can be designated as “Mail Present” or “straight ahead” sensors and can be arranged adjacent to or as part of each section of the destacker 204. As shown in FIG. 4, for example, sensors 275 (i.e., “Mail Present” sensors) are respectively arranged adjacent and in an overlapping manner with respective holding components 260. Optionally, destacker 204 can also include one or more sensors 280, which can also be in the form of “Mail Present” sensors. These sensors, too, can be used to determine presentation information. In various embodiments, each sensor 280 may be associated with a friction belt 250 and/or intelligent sensor 270. See also FIGS. 7-9, for example.

As can be seen in particular with reference to FIG. 4, an intelligent sensor in the form of an encoder 270, for example, can be associated with each dynamic component 250 and/or holding or retaining component 255 (e.g., friction belt portions and switched vacuum chambers, respectively). As indicated above, each friction belt portion 250 and associated vacuum chamber 255 can comprise a section of the destacker 204, and these multiple sections can be fired accordingly, based on presentment information associated with the leading item, to move only the friction belt portion or portions 250 which are adjacent to the leading item. As one or more of the friction belts 250 is caused to move, the leading item is frictionally engaged by the one or more friction belts 250 and is caused to move in an output direction. For each friction belt portion 250 that is activated, its corresponding switched vacuum chamber 255 may also be activated to hold or assist with holding the leading item against the friction belt portion 250.

The foregoing sections, components (including dynamic and/or holding components), and sensors (both “intelligent-type” and “position-type”) of the destacker 204 can be arranged or positioned in any suitable way. In various embodiments, overall section and sensor configuration and positioning can be based on a known size, dimension, and/or type of item or items to be destacked.

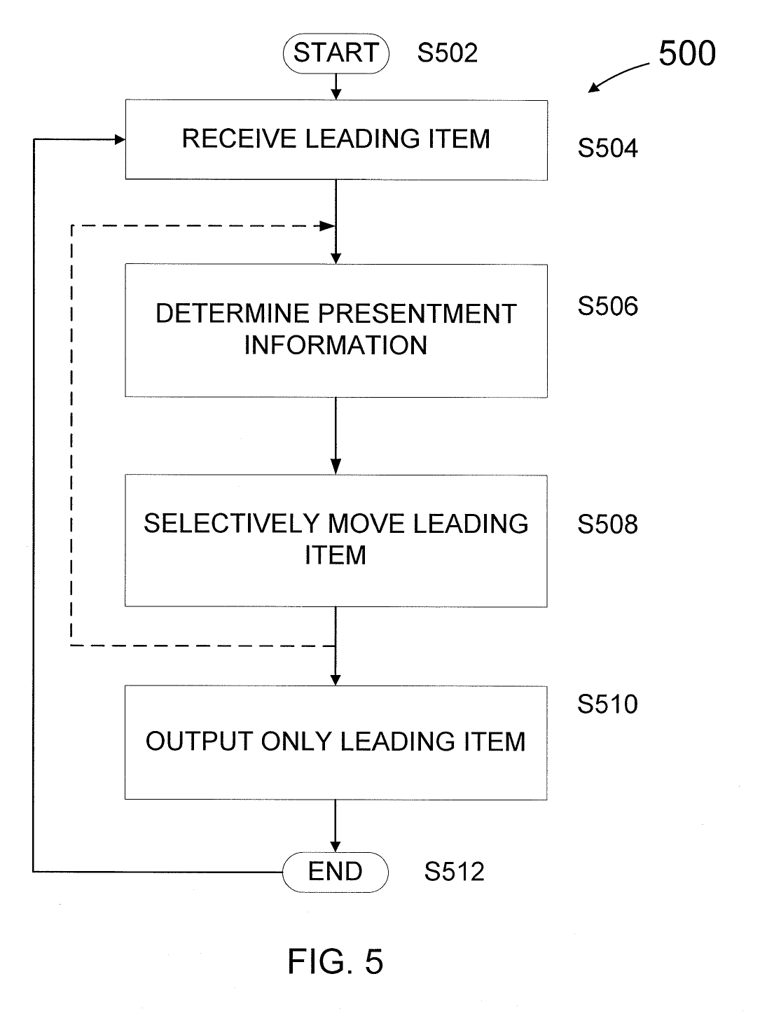

FIG. 5 is a flow chart of a method 500 according to various embodiments.

The method 500 starts at S502 and can proceed to S504 where a leading item is received. In various embodiments, the leading item can be received at a front face of a destacker. The leading item can be followed by a single-file stream of following items. Such items can be received at a feeder which feeds items to the destacker, substantially as described above. After S504, the method can proceed to S506, where a plurality of sensors can sense presentment information associated with the first item, such as positioning, movement, leading edge, trailing edge, and/or pressure or force information associated with the leading item. Incidentally, such presentment information can also include information about one or more items behind the leading item.

After S506, the method can proceed to S508. At S508, the leading item can be moved based on the presentment information or data. In various embodiments, the presentment data or information can be sensed by one or more sensors at various sections of the destacker. In various embodiments, the sensing can be performed by a destacker, substantially as described above. The presentment data or information may be substantially unique for the presentment of this particular leading item and one or more following items associated therewith. In response to the presentment information, the leading item can be moved, without movement (unwanted, unacceptable, or otherwise) of any of the following items. In various embodiments, the leading item can be moved in stages, in a controlled manner, across the front face of the destacker and some or all destacker sections, after which it can be output to an out-feed transfer, for example. That is, at S508, the leading item may be subjected to one or more distinct movements prior to being output from the destacker to the out-feed transfer. Such movement of the leading item in stages can be performed by selective activation of various sections (including components and/or sensors) of the destacker, substantially as described above. The dashed arrow from S508 returning back to S506 can indicate that the determining presentment information and selectively moving the leading item can be repeated until the leading item is ready for output.

After S508, the method can proceed to S510, where only the leading item can be output to an out-feed transfer, for example, such as the pinchwheel 206 shown in FIGS. 2 and 3.

After S510, the method can determine whether further items are to be destacked, and, if so, the method returns to S504, where the item next behind the leading item just output is deemed the “new” leading item. If no further items are to be destacked after S510, the method can proceed to S512 where the method can end.

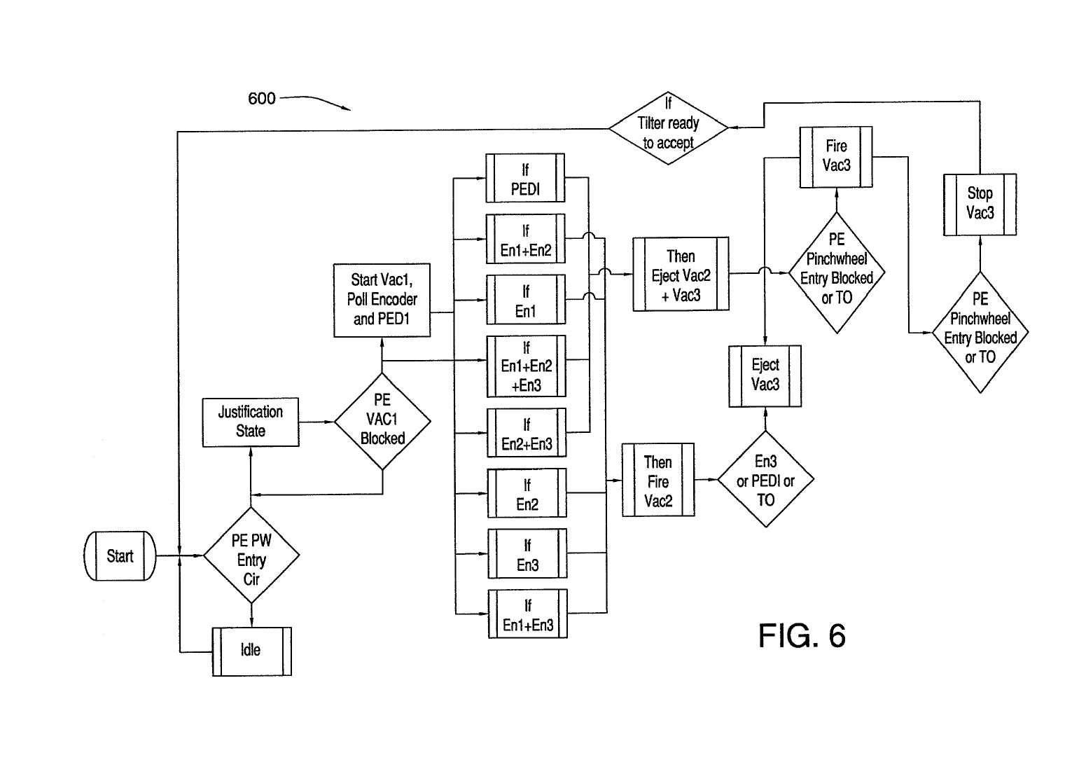

FIG. 6 is a flow chart of a method 600 according to various embodiments of the disclosed subject matter. Generally speaking, method 600 includes a control method for selective movement of a leading item based on sensed presentment information associated with the leading item. Similar to the method 500 discussed above, method 600 can continuously sense and detect presentment information associated with a current leading item and selectively activate various destacker sections (including dynamic components, such as friction belts and holding components, such as vacuum chambers) based on the sensed presentment information. After destacking of each leading item, the method 600 can repeat itself for the next leading item by adapting an activation sequence of destacker sections based on the particular presentment situation for this next leading item. The method 600 shown in FIG. 6 can be a more detailed representation of the method 500 discussed above. Optionally or alternatively, method 600 can be implemented to control items as will be described later with respect to FIGS. 7-9.

Regarding method 600, the method starts at the “Start” block on the bottom left-hand side as shown in FIG. 6. The method can proceed to the decision diamond “PE PW Entry Cir,” whereby an item entry portion is either in an idle state awaiting for items to be fed thereto or enters an optional justification operation. For the justification operation, items can be justified and/or it can be determined whether the items are in a justified state. For example, in reference to FIG. 3, items may be justified with respect to ledge 203. In order to determine whether the items are justified, the method may proceed to decision diamond “PE VAC1 Blocked” to determine if a first section of components, such as any of the sensors (intelligent or otherwise) associated with that section. That is, it can be determined whether the first section of components closest to the ledge 203, for example, has item(s) positioned thereat. If not blocked, the method 600 can return to the justification operation. If blocked, the method 600 can move to “Start Vac1, Poll Encoder and PED1” and to the conditional “If” blocks. The “Start Vac1, Poll Encoder and PED1” block can indicate starting or activation of one or more dynamic and/or sensing components. Optionally, up to this point the components may be in a standby or idle mode. The “If” blocks indicate conditions or states of various sensors. Incidentally, the “If” blocks shown in FIG. 6 are in no way meant to limit the possible conditional expressions implemented. Based on the conditional “If' blocks, the method 600 can proceed to move a leading item for outputting or ejecting. For examlpe, after the “If” blocks, the method 600 can proceed to either the “Then Eject Vac2+Vac3” block or the “Then Fire Vac2” block, wherein corresponding components are activated or fired to more the leading item, the former of which ejecting the leading item. From the leading item movement stages the method 600 can determine whether the leading items has been fully ejected, such as fully ejected from the destacker through a pinchwheel. When all of the items have been destacked, the method 600 can stop, deactivate, or otherwise go to an idle state until more items are provided. Optionally, the method 600 can determine whether a feeder, such as a tilter, is ready to accept more items.

FIGS. 7-9 are exemplary item (i.e., item) positioning scenarios for staged destacking according to various of the disclosed subject matter, wherein various mail pieces are destacked. The scenarios presented below are merely examples and are not meant to limit the number of possible scenarios encountered or supported by various embodiments of the disclosed subject matter. Nor are such scenarios intended to limit or constrain operation of various embodiments of the disclosed subject matter.

FIG. 7 is a diagram representation for staged destacking of items arranged according to a first scenario. In this first scenario, “MAIL-1” represents a leading item and “MAIL-2” and “MAIL-3” represent following items. In this scenario, MAIL-1 can be picked off, individually, before either MAIL-2 or MAIL-3, and without unwanted or unacceptable movement of either MAIL-2 or MAIL-3. Note that the mail pieces in FIG. 7 are unjustified with respect to the feeder ledge (shown as a vertical dashed line). A right-to-left going arrow at the bottom of the figure represents the “mail moving direction.”

Mail present sensors #1 and #2 (e.g., sensors 275 in FIG. 4) can both sense whether MAIL-1 is present. In this scenario, based on the readings of mail present sensors #1 and #2 that MAIL-1 is present at mail present sensor #2, pickoff #3 (e.g., friction belt 250/switched vacuum chamber 255) can be fired to move its friction belt (which is in friction contact with MAIL-1) such that MAIL-1 is moved in the mail moving direction. Note also that firing of pickoffs may also include activation of corresponding switched vacuum chambers. Intelligent sensor #3 (e.g., encoder 270) can sense motion of MAIL-1 and intelligent sensor #2 can sense motion of MAIL-1, within a preset time period as MAIL-1 moves toward and eventually in contact with it. In various embodiments, the time period may be based on data received by any of the other sensors, such as mail present sensor #2. Once pickoff #2 is covered by MAIL-1 or it is otherwise determined that MAIL-1 is sufficiently adjacent to pickoff #2's associated friction belt, pickoff #2 is fired to move its friction belt (which is in friction contact with MAIL-1) to move MAIL-1 in the mail moving direction, and after a time delay, pickoff #3 is turned off. Motion at intelligent sensor #2 can be sensed. Within a preset time period, intelligent sensor #1 can sense motion. In various embodiments, MAIL-1 may now be justified (e.g., aligned with feeder ledge or roughly aliged with feeder ledge) and pickoff #2 can be turned off. When the pinch wheel set is ready for mail, pickoff #1 can be fired to move its friction belt (which is in friction contact with MAIL-1) to move MAIL-1 in the mail moving direction and thereby output only MAIL-1 from the destacker to and through the pinch wheel set, for example. Adaptive destacking may then continue for MAIL-2, MAIL-3, and any other following items to MAIL-N, with MAIL-2 now becoming the “leading” item.

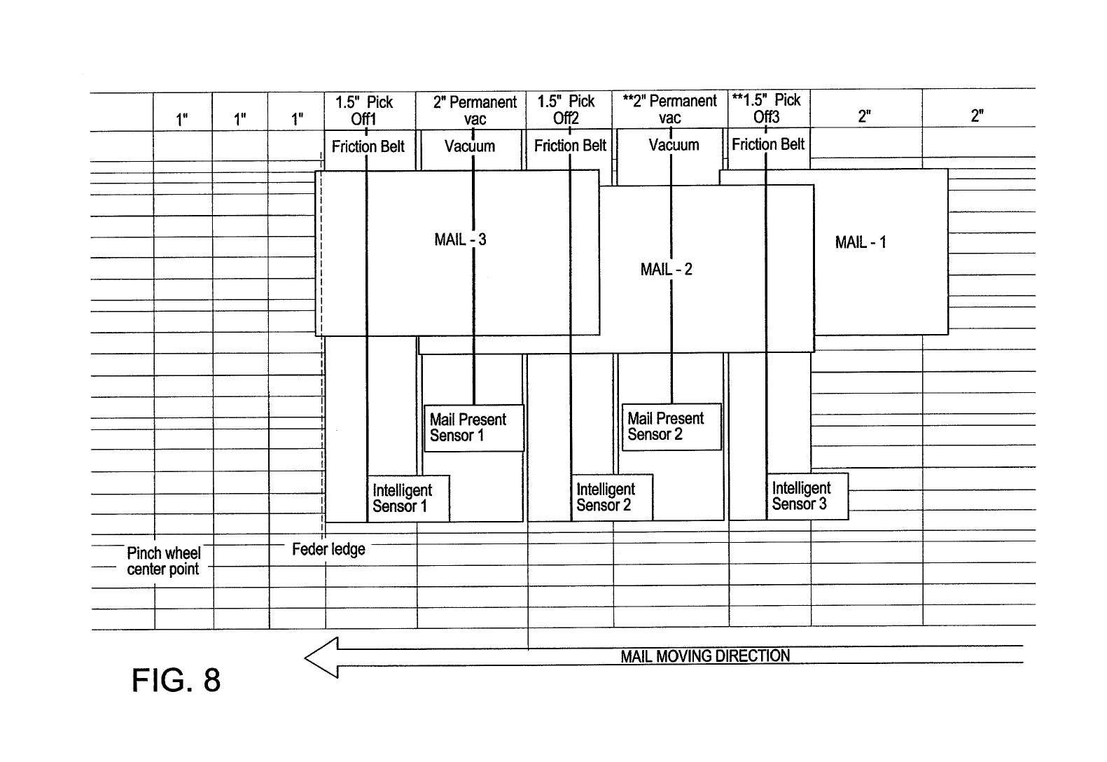

FIG. 8 is a diagram representation for staged destacking of items arranged according to a second scenario. As with scenario 1 above, in this scenario MAIL-1 is the leading item and “MAIL-2” and “MAIL-3” are following items. In this scenario, MAIL-1 can be picked off, individually, before either MAIL-2 or MAIL-3, and without unwanted or unacceptable movement of either MAIL-2 or MAIL-3. Note that the mail pieces are unjustified with respect to the feeder ledge (shown as a vertical dashed line). A right-to-left going arrow at the bottom of the figure represents the “mail moving direction.”

Mail present sensors #1 and #2 (e.g., sensors 275 in FIG. 4) can both sense to see whether MAIL-1 is present. In this scenario, based on the readings of mail present sensors #1 and #2, pickoff #3 (e.g., friction belt 250/switched vacuum chamber 255) can be fired to move its friction belt (which is in friction contact with MAIL-1) and MAIL-1 can be moved in the mail moving direction. Note also that firing of pickoffs may also include activation of corresponding switched vacuum chambers. Intelligent sensor #3 (e.g., encoder 270) can sense motion of MAIL-1, and intelligent sensor #2 can sense motion of MAIL-1, within a preset time period, as MAIL-1 moves toward and eventually in contact with it. In various embodiments, the time period may be based on data received by any of the other sensors, such as mail present sensor #2. Once pickoff #2 is covered or it is otherwise determined that MAIL-1 is sufficiently adjacent to pickoff #2′s associated friction belt, pickoff #2 can be fired to move its friction belt (which is in friction contact with MAIL-1) to move MAIL-1 in the mail moving direction, and after time delay, pickoff #3 is turned off. Motion at intelligent sensor #2 can be sensed. Within a preset time period, intelligent sensor #1 can sense motion. MAIL-1 may now be justified (e.g., aligned with feeder ledge or roughly aliged with feeder ledge) and pickoff #2 is turned off. When the pinch wheel set is ready for mail, pickoff #1 can be fired to move its friction belt (which is in friction contact with MAIL-1) to move MAIL-1 in the mail moving direction and thereby output only MAIL-1 from the destacker to and through the pinch wheel set, for example. Adaptive destacking may then continue for MAIL-2, MAIL-3, and any other following MAIL-N, with MAIL-2 now becoming the “leading” item. A right-to-left going arrow at the bottom of the figure represents the “mail moving direction.”

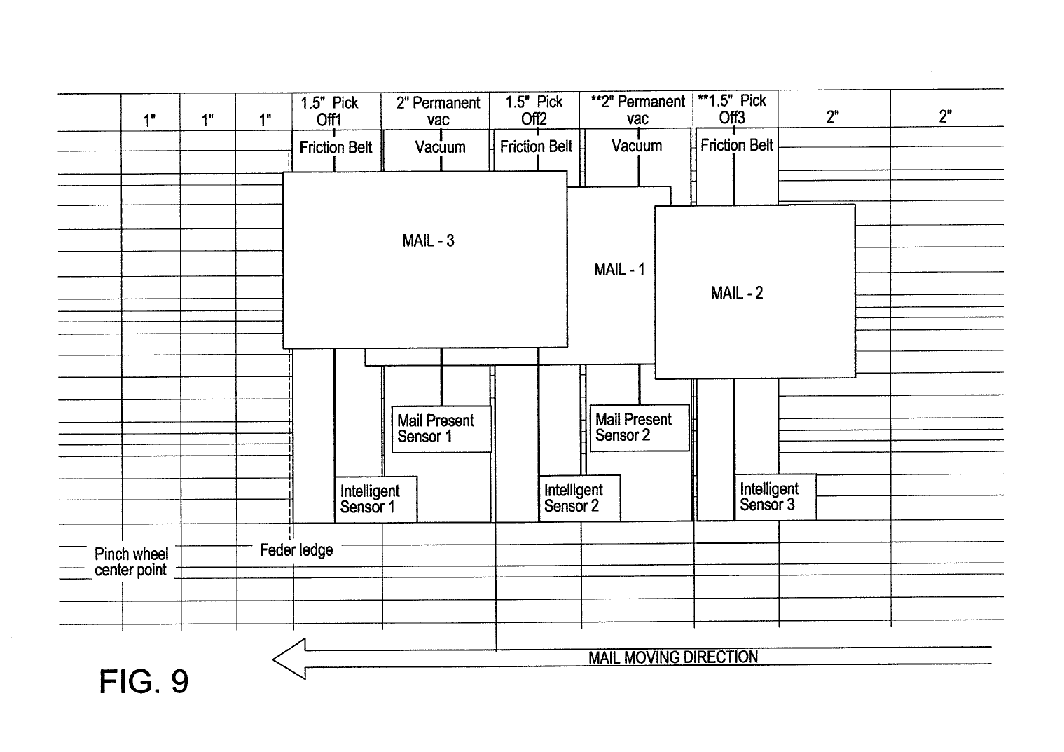

FIG. 9 is a diagram representation for staged destacking of items arranged according to a third scenario. As with the scenarios above, in this scenario MAIL-1 is the leading item and “MAIL-2” and “MAIL-3” are following items. In this scenario, MAIL-1 can be picked off, individually, before either MAIL-2 or MAIL-3, and without unwanted or unacceptable movement of either MAIL-2 or MAIL-3. The mail pieces are unjustified with respect to the feeder ledge (shown as a vertical dashed line).

Mail present sensors #1 and #2 (e.g., sensors 275 in FIG. 4) can both sense whether MAIL-1 is present. In this scenario, based on the readings of mail present sensors #1 and #2 that MAIL-1 is present at both sensors, pickoff #2 (e.g., friction belt 250/switched vacuum chamber 255) can be fired to move its friction belt (which is in friction contact with MAIL-1) and MAIL-1 can be moved in the mail moving direction. Note also that firing of pickoffs may also include activation of corresponding switched vacuum chambers. Intelligent sensor #2 (e.g., encoder 270) can sense motion of MAIL-1 and intelligent sensor #1 can sense motion of MAIL-1, within a preset time period, as MAIL-1 moves toward and eventually in contact with it. In various embodiments, the time period may be based on data received by any of the other sensors. Once pickoff #1 is covered or it is otherwise determined that MAIL-1 is sufficiently adjacent to pickoff #1's associated friction belt, pickoff #1 can be fired to move its friction belt (which is in friction contact with MAIL-1) to move MAIL-1 in the mail moving direction, and after time delay, pickoff #2 can be turned off. MAIL-1 may now be justified (e.g., aligned with feeder ledge or roughly aliged with feeder ledge) and pickoff #1 can be turned off. When the pinch wheel set is ready for mail, pickoff #1 can be fired to move its friction belt (which is in friction contact with MAIL-1) to move MAIL-1 in the mail moving direction and thereby output only MAIL-1 from the destacker to the pinch wheel set, for example. Adaptive destacking may then continue for MAIL-2, MAIL-3, and any other following MAIL-N, with MAIL-2 now becoming the “leading” item.

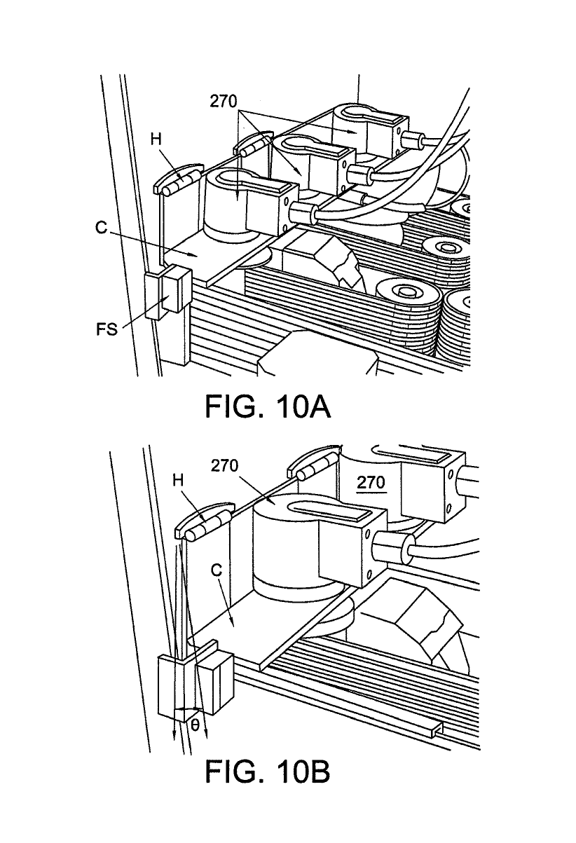

FIGS. 10A and 10B show a portion of a system for sensing or detecting an amount of force or pressure associated with items presented for destacking or picking off. Various embodiments of the disclosed subject matter also include a method for sensing or detecting an amount of force or pressure associated with items presented for destacking or picking off.

In the method according to various embodiments of the disclosed subject matter (not explicitly shown), a sensed or detected amount of force or pressure can be fed-back to modify a pressure or force of the stack acting at a destacker, for example. For instance, a biasing apparatus, such as a paddle, pushrod, or other mechanical apparatus can push the stack of items toward the destacker. If the force or pressure at the destacker, for instance, exceeds a predetermined amount, the biasing apparatus can be controlled so as to decrease the force or pressure the stack of items exerts at the destacker (e.g., on the front face of the destacker). The sensed force or pressure amount also can indicate that the force of the stack needs to be increased. In such as case, the biasing apparatus can be controlled to increase the force or pressure that the stack exerts at the destacker. Orientation of an item feeder also may be changed to modify the force or pressure exerted by the stack of items at the destacker. For example, the item feeder may be inclined or declined such that the effect of gravity and/or the combined weight of the items contributes to the force or pressure at the destacker.

According to a system for sensing or detecting an amount of force or pressure associated with items presented for destacking or picking off, the system can include one or more sensors or detectors to sense or detect a force or a pressure of items presented for destacking or picking off. Force or pressure can be sensed, detected, or otherwise determined directly or indirectly. For example, FIGS. 10A and 10B show such a force or pressure sensor FS that can detect an amount of movement of a carriage C about a hinge H, wherein the carriage carries the aforementioned “intelligent” sensors 270 (e.g., encoders), for example. In various embodiments, the stack of items can push on the intelligent sensors 270 and the carriage C can move about a hinge H an amount θ based on the pressure or force of the stack. The amount of movement can be sensed by sensor FS and correlated to the pressure or force of the stack. In various embodiments, either the sensor FS or a controller (not shown) can correlate the pressure or force based on the amount of movement. Various embodiments also contemplate that the carriage is spring-loaded and biased back toward the stack, wherein movement of the carriage and/or a characteristic of the spring can be monitored to determine pressure of the stack. In various embodiments, this pressure or force signal can be fed back to a controller, for example, for modification of the pressure or force of the stack at the destacker.

While the disclosed subject matter has been described in conjunction with a number of embodiments, the disclosed subject matter is not to be limited to the description of the embodiments contained herein, but rather is defined by the claims appended hereto and their equivalents. It is further evident that many alternatives, modifications and variations would be or are apparent to those of ordinary skill in the applicable arts. Accordingly, all such alternatives, modifications, equivalents, and variations that are within the spirit and scope of the disclosed subject matter.

What is claimed is:

1. A multi-staged destacking apparatus for continuously and sequentially destacking mail items in a stack, the apparatus eliminating or reducing substantially simultaneous output of multiple mail items without unwanted or unacceptable movement of one or more following mail items, the apparatus comprising:
a first stage of components configured to move a leading mail item in the stack of mail items in an out-feed direction;
a second stage of components configured to move the leading mail item in the out-feed direction;
a third stage of components configured to move the leading mail item in the out-feed direction;
a first vacuum portion;
a second vacuum portion;
a first mail item presence sensor; and
a second mail item presence sensor,
wherein each of said first, second, and third stages of components includes a friction belt portion, a third vacuum portion, and a sensor that senses one of position and movement,
wherein the first, second, and third stages are operative to be selectively activated based on presentment information associated with the leading mail item,
wherein the presentment information includes one or more of position information of the leading mail item, movement information of the leading mail item, transition information from the leading mail item to the immediately following item, leading edge information regarding the leading item, trailing edge information regarding the leading item, leading edge information regarding one or more following items, trailing edge information regarding one or more following items, and position information of one or more following mail items,
wherein the presentment information is obtained using one or more of said sensors, including the first mail item presence sensor, the second mail item presence sensor, and the sensors that sense one of position and movement,
wherein, in a front view, the first vacuum portion and the first mail item presence sensor are positioned between the first and second stages of components and the second vacuum portion and the second mail item presence sensor are between the second and third stages of components, and
wherein the first and second vacuum portions are operative to be in an on state at all times during the continuous and sequential destacking by the multi-staged destacking apparatus.

2. The apparatus of claim 1, wherein the mail items are pieces of mail including at least one letter, at least one flat, or at least one letter and at least one flat.

3. The apparatus of claim 1, wherein the stack is neither sorted, nor justified, nor groomed.

4. The apparatus of claim 1, wherein some or all of the mail items of the stack do not match in size, dimension, or type with respect to one or more other mail items of the stack.

5. The apparatus of claim 1, wherein a vacuum of each of the first and second vacuum portions is less than a vacuum of each of the second vacuum portions of the first, second, and third stages, respectively.

6. The apparatus of claim 1, wherein the sensor of each of said first, second, and third stages of components is a wheeled encoder.

7. The apparatus of claim 1,
wherein the first mail item presence sensor is arranged in overlapping fashion with the first vacuum portion from the front view,
wherein the second mail item presence sensor is arranged in overlapping fashion with the second vacuum portion from the front view, and
wherein each said friction belt is arranged in overlapping fashion with respect to corresponding third vacuum portions from the front view.

8. A method for receiving a plurality of items in series in a first format and outputting items in a second format in the same order as the received series, the method comprising:
receiving the series of items in the first format, the series of items including a first item and a plurality of successive items;
automatically and continuously detecting at least one of presence, position, movement, edge, and transition information associated with the first item while the first item is still in the first format;
automatically moving the first item in response to said automatically and continuously detecting, said moving including staged movement of the first item without unwanted or unnecessary movement of any of the successive items;
after said moving the first item, automatically outputting only the first item in the second format; and
continuously repeating said automatically detecting, moving, and outputting for each next first item in the series of said items.

9. The method of claim 8, wherein some or all of the items are unsorted, unjustified, or ungroomed, and some or all of the items do not match in size, dimension, or type with respect to other of said items.

10. The method of claim 8, wherein the first format is a stack in a thickness direction of the items and the second format is generally single file in a length direction of the items.

11. The method of claim 8, wherein said staged moving includes more than one stage.

12. The method of claim 8, wherein said staged moving includes multiple, distinct movements of the first item prior to said outputting.

13. The method of claim 8, wherein the items are pieces of mail including at least one letter, at least one flat, or at least one letter and at least one flat.

14. The method of claim 8, further comprising:
detecting a force or a pressure associated with the series of items with the first item in the first format; and
determining whether to modify the force or pressure associated with the series of items, and modifying the force or pressure if it is determined that the force or pressure is to be modified, otherwise not modifying the force or pressure.

15. A system for continuously and substantially in sequence destacking articles sequentially arranged in a stack, the system comprising:
means for in-feeding the stack of articles;
means for selectively moving a leading article in the stack in one or more sequential movements while preventing unwanted or unacceptable movement of one or more following articles, said means for selectively moving continuously attempting to detect a presence of the leading article and adapting a destacking movement sequence for the leading article based on results of its presence detection attempts; and
means for outputting only the selectively moved leading article.

16. The system of claim 15, further comprising:
a force or pressure modifying means for adjusting a force or pressure associated with the stack of articles, the modifying being based on a force or pressure measurement associated with said means for selectively moving, and
wherein said means for selectively moving is a staged-destacker having a plurality of friction elements, plurality of vacuum elements, and a plurality of sensors, the friction elements and a portion of the vacuum elements being selectively activated to move the leading item, based on inputs received from one or more of the sensors.

17. The system of claim 15, wherein the articles are pieces of mail, each said piece of mail being one of a letter or a flat.

18. The system of claim 15, wherein the articles are substantially uniform in size and shape.

19. A nontransitory computer readable storage medium having stored thereon software instructions that, when executed by a processor, cause the processor to perform operations comprising:
receiving automatically and continuously detected data regarding at least one of presence, position, movement, edge, and transition information associated with at least one of a leading item and one or more following items in a stack of items;
adapting a staged movement sequence for the leading item based on said receiving; and
automatically outputting instructions to cause staged movement of the leading item in the stack in correspondence with the adapted staged movement sequence while preventing unwanted or unacceptable movement of any of the following items.

20. The nontransitory computer readable storage medium of claim 19, wherein the software instructions, when executed by the processor, cause the processor to further perform the following operations comprising:
receiving detected data regarding a force or a pressure associated with the stack of items; and
determining whether to modify the force or pressure associated with the stack of items, and outputting instructions to modify the force or pressure if it is determined that the force or pressure is to be modified.
